(19) United States
(12) Patent Application Publication
(10) Pub. No.: US 2010/0036768 A1
(43) Pub. Date: Feb. 11, 2010

(54) SHARE OF WALLET BENCHMARKING

(75) Inventor: Laura DiGioacchino, San Mateo, CA (US)

Correspondence Address: Visa USA c/o Duane Morris LLP;Attn: James Sze, Esq., 101 West Broadway, Suite 900, San Diego, CA, 92101, US

(73) Assignee: Visa U.S.A. Inc., San Francisco, CA (US)

(21) Appl. No.: 12/397,847

(22) Filed: Mar. 4, 2009

Related U.S. Application Data
(60) Provisional application No. 61/188,392, filed on Aug. 8, 2008.

(51) Int. Cl. G06Q 40/00

(52) U.S. Cl. 705/39

(57) ABSTRACT

Signals are received representing transactions made by a customer or domestic unit during a given period from a plurality of financial institutions. The transactions affect one or more accounts of the customer or domestic unit at each of the plurality of financial institutions. Data are stored representing the transactions in a machine readable storage medium. At least one benchmark is computed. The benchmark is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions. Data representing the benchmark are transmitted to the first financial institution.

### CROSS-REFERENCE TO RELATIONS APPLICATIONS

This application claims the benefit of U.S. Provisional Patent Application No. 61/188,392, filed Aug. 8, 2008, which application is expressly incorporated by reference herein in its entirety.

### FIELD OF THE INVENTION

Aspects of the present invention relate to methods and systems for analyzing information from a plurality of financial transactions by a customer of a financial institution.

### BACKGROUND

A given financial institution (FI) may have a number of accounts with a given customer. For example, the FI may issue credit and/or debit cards to its customer. To increase its profits, it is desirable for the FI to maintain or improve its relationship with the customer, by increasing the number and size of transactions the customer makes using its account with the FI.

To monitor the health of its account relationship, an FI uses an analysis tool that allows the FI to view the total transaction volume for an account of the customer as it changes over time.

Additional analytical tools are desirable.

### SUMMARY

In some embodiments, a method comprises receiving signals representing transactions made by a customer or domestic unit during a given period from a plurality of financial institutions. The transactions affect one or more accounts of the customer or domestic unit at each of the plurality of financial institutions. Data are stored representing the transactions in a machine readable storage medium. At least one benchmark is computed. The benchmark is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions. Data representing the benchmark are transmitted to the first financial institution.

In some embodiments, a method comprises transmitting signals representing transactions made by a customer or domestic unit during a given period from a first financial institution to a transaction aggregator for storing of data representing the transactions in a machine readable storage medium by the transaction aggregator. The transactions affect one or more accounts of the customer or domestic unit at the first financial institution. The transaction aggregator receives additional data representing additional transactions affecting one or more accounts of the same customer or domestic unit at one or more second financial institutions. Signals are received from the transaction aggregator, representing at least one benchmark that is in part based on the data representing the transactions of the customer or domestic unit at the first financial institution and in part based on data corresponding to a plurality of accounts of the customer or domestic unit at a plurality of financial institutions. The plurality of financial institutions includes the first financial institution and the one or more second financial institutions.

In some embodiments, a system comprises a programmed processor coupled to a network for receiving signals representing transactions made by a customer or domestic unit during a given period from a plurality of financial institutions. The transactions affect one or more accounts of the customer or domestic unit at each of the plurality of financial institutions. A storage device is coupled to the processor. The processor causes the storage device to store data representing the transactions therein. The processor is programmed to compute at least one benchmark that is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions. The processor is programmed to transmit data representing the benchmark to the first financial institution.

### BRIEF DESCRIPTION OF THE DRAWINGS

FIG. 1 is a block diagram of a system according to one embodiment.

FIG. 2 is a block diagram of a computer system for use in the system of FIG. 1.

FIG. 3 is a flow chart of a method for receiving, storing and analyzing transaction data from a plurality of FIs.

FIG. 4 is a flow chart of a method for associating data related to a customer or domestic unit from a plurality of sources.

FIG. 5 is a flow chart for computing benchmarks from the aggregated data.

FIG. 6 is a flow chart for activities of an FI that provides transaction data to, and receives benchmark data from, the system of FIGS. 1 and 2.

### DETAILED DESCRIPTION

This description of embodiments is intended to be read in connection with the accompanying drawings, which are to be considered part of the entire written description.

As used herein, the term, “instrument” refers to a portable device used by a customer for a financial transaction, and may be in the form of a card, fob, wireless telephone, personal digital assistant, smart card, or the like. This usage of “instrument” applies equally when used in the terms “financial instrument”, “credit instrument” and “debit instrument”.

The inventor has recognized that the relationship between an FI and its customer is more fully understood when viewed in the context of the customer's total spending, which may use multiple accounts, and possibly multiple FIs. A given FI may have a number of accounts with a given customer. Over time, the customer's spending habits may change, resulting in increased or reduced spending. The customer may also change the manner in which it conducts transactions, by increasing or decreasing its use of credit card purchases (relative to electronic funds transfers and cash purchases). The customer may also create account relationships with other FIs, and conduct some his or her transactions using accounts or instruments of the other FIs.

Some embodiments described below provide the FI more complete information regarding its customer's total spending, and categories of spending. This information may extend beyond the account relationships between that FI the customer, and may extend to other FIs with whom the customer has account relationships.

In some embodiments, the FI may use this information to cross sell its products to the customer. In some embodiments, the FI may use this information to target its promotions and incentive programs to the customer.

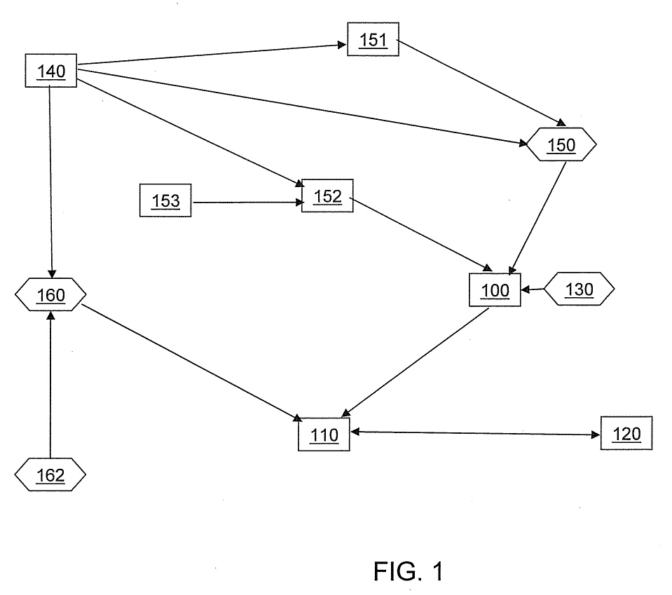

FIG. 1 is a schematic diagram of a system in which transaction aggregates are collected from several sources and stored by a transaction aggregating application 100. Transaction data for individual accounts of one or more customers are provided by a plurality of FIs 140 that issue credit and debit cards or devices (financial instruments) to the customers. An account linking module 152 associates multiple accounts belonging to a customer with other accounts of the same domestic unit (e.g., including other accounts of the same customer, and the customer's spouse or domestic partner, regardless of whether at the same FI and/or at different FIs) and provides the association data to the transaction aggregating application 100. The account linking module 152 may include a database management system (DBMS) that compares customer identity and address records, to determine whether two accounts are owned by the same customer or domestic unit.

The account linking module 152 may in turn receive transaction data from FIs 140, relating to debit cards, credit cards, and pre-paid cards. In some embodiments, the account linking module 152 also receives transaction data from other participating third party providers 153 of financial transaction data. Such third parties may include, for example, a service that provides a secure Internet mechanism for a customer to send a payment to a merchant without providing a credit card or bank account number to that merchant, or receive payments from a purchaser without receiving a credit card or bank account number from the purchaser. Other third party providers 153 may include digital marketing performance service providers that collect data on internet purchase and/or sale transactions and sell or exchange that data. Other types of third party providers of transaction data may include, but are not limited to online auction and reverse auction websites, and e-tailers.

In addition, an intermediary, such as another transaction aggregating processor 151 may collect transaction data from certain FIs and forward that data to the transaction aggregating application 100. For example, if the transaction aggregating node 100 processes “VISA®” transactions, then the aggregating processor 151 may process credit card transactions for a card network other than “VISA®”.

The transaction aggregating application 100 may receive the transaction data by way of a variety of computer networks. In some embodiments, the transaction aggregating application 100 receives the transaction data by way of an authorization, clearing and settling network 130 that is used by merchants to obtain rapid authorization of point of sale (POS) purchases, used by credit card acquirers that provide acceptance services to the merchants, and used for settlement transactions with the credit card issuer institutions that issue the credit cards to the customer, such as the “VISANET™” global clearing and settlement system provided by Visa, Inc. of Foster City, Calif. In some embodiments the transaction aggregating application 100 receives the transaction data via one or more external networks 150, which may include a local area network (LAN), a wide area network (WAN), Internet, or any combination of the three. These may include data concerning transactions using credit instruments from FIs that do not use the authorization, clearing and settling network 130.

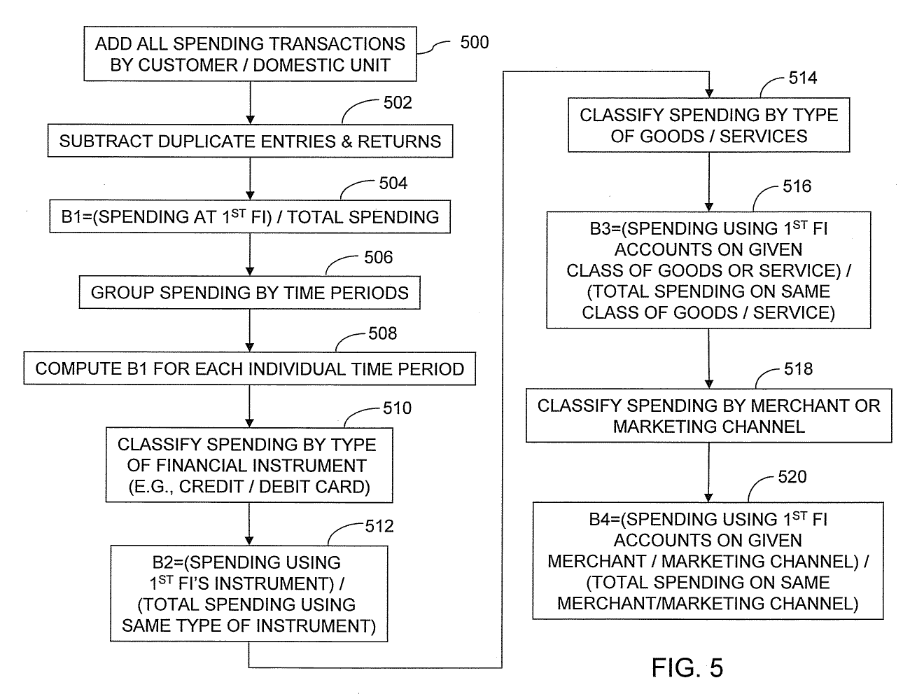

The transaction aggregate data from the application 100 are used by a benchmarking module 110 to provide a FI level benchmarking service. The benchmarking module 110 provides the FI 120 more complete information about the total spending of its customer, including purchases made using the services of other FIs and financial instruments, so that the FI 120 can target promotions and programs to improve its share of the customer's total spending in areas currently serviced by other providers. Details of a non-exclusive set of examples of benchmarking services are discussed below in the description of FIG. 5. The benchmarking module 110 also receives setup information about the FI 120 from the financial institution profile 160, which includes corporate licensing data 162 that determines the financial relationships between that FI 120 and the operator of system 100.

The FI level benchmarking module 110 provides the benchmark data to subscribing FIs 120. In some embodiments, the subscribers 120 to whom the benchmarking module 110 makes the FI level benchmarking service available include all participating FIs 140 that agree to participate by providing transaction data to the transaction aggregating application 100. In some embodiments, the benchmarking services are made available as a separate premium service.

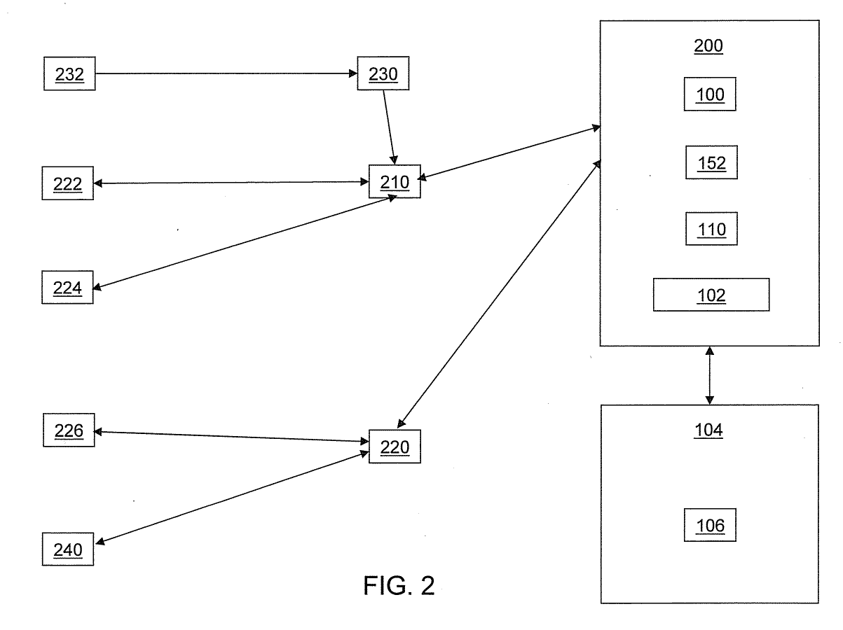

FIG. 2 is a block diagram of an example of an architecture for implementing the transaction aggregation and benchmarking service. A programmed processor 200 is coupled to a network 210 for receiving signals representing transactions made by a customer or domestic unit during a given period from a plurality of financial institutions 220, 222, 224. The transactions affect one or more accounts of the customer or domestic unit at one or more of the plurality of financial institutions 222, 224, 226. The programmed processor 200 may includes the transaction aggregation program 100, and its benchmarking module 110 and account linking module 152. In some embodiments, a database management system (DBMS) 102 may provide underlying data indexing and management functions. For example DBMS 102 may be the Oracle Relational Database Management System sold by Oracle Corporation of Redwood Shores, Calif., or other commercial or proprietary DBMS.

At lease one storage device 104 is coupled to the processor 200. The processor 200 causes the storage device 104 to store data representing the transactions therein. The storage device may include multiple storage devices of one or more types, and may include solid state memory, magnetic and/or optical disk, magnetic tape, or the like.

The processor 200 is coupled to one or more computer networks to receive the transaction data from multiple FIs, and to transmit data representing the benchmark to the subscribing FIs. In some embodiments, the transaction data are received over an authorization, clearing and settling network 210, such as the “VISANET™” network. In some embodiments, the transaction data are received via an external network 220, which may be a LAN, WAN or the Internet. In other embodiments, transaction data are received by way of both networks 210 and 220. The transaction data from a given customer may be received over the network 210 from the computer 222, 224, 226 of the FI that issued the financial instrument (e.g., debit, credit or prepaid card) to the customer, or from a third party information system 240. Other transaction data from the same customer may be received over the network 210 from the computer 230 of an acquirer FI that accepts payment transactions from a merchant at which the customer uses a POS terminal 232. Transaction data from other FIs and third parties may be received via the external network.

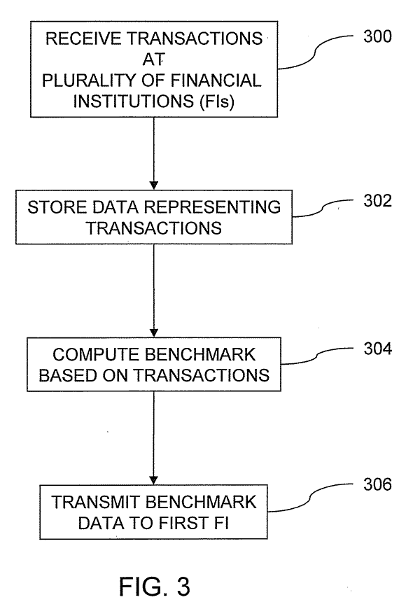

FIG. 3 is a flow chart of the general process performed by the transaction aggregation application 100.

At block 300, transaction aggregation application 100 receives signals representing transactions made by a customer or domestic unit during a given period from a plurality of FIs 222, 224, 226. The transactions affect one or more accounts of the customer or domestic unit at each of the plurality of financial institutions. FIs 222, 224, and 226 may be issuers of credit cards, debit cards, prepaid cards, automated clearing house (ACH), checks or any combination thereof. The transactions may include financial transactions (i.e., those in which money is transferred between FIs) in settlement of credit or debit card purchases. The transactions may include electronic transfers (payments) from the user's bank account to a merchant. The transactions may also include non-financial transactions (e.g., transfers between different accounts of the same customer at the same financial institution).

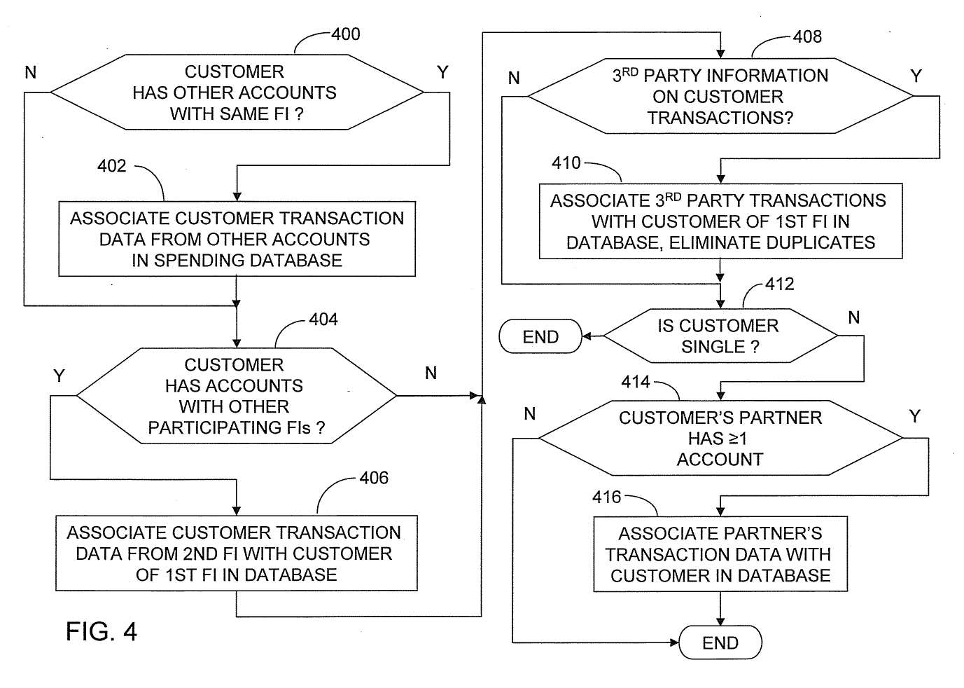

At block 302, the transaction aggregation node 100 stores the data representing the transactions in the aggregated transaction database 106 in the machine readable storage device 104. In some embodiments all of the transaction data are stored in the aggregated transaction database 106. The database includes information identifying transactions that are linked to the same customer or domestic unit, regardless of whether the transactions involve the same account, different accounts in the same FI, or accounts in different FIs. In other embodiments, only transactions related to spending (i.e., financial transactions) are stored in the aggregated transaction database 106. The process of associating records in the database from multiple accounts and FIs is discussed below in the description of FIG. 4.

At block 304, the FI level benchmarking module 110 of transaction aggregation node 100 computes at least one benchmark that is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions. The process of computing benchmarks is discussed below in the description of FIG. 5.

At block 306, the FI level benchmarking module 110 transmits data representing the benchmark(s) to the first financial institution. Without requiring disclosure to the first FI of details of the customer's transactions with other FIs, these benchmarks can provide the first FI with a picture of its percentage share of the customer's spending transactions, and identify opportunities for cross-selling and promotional programs.

Referring now to FIG. 4, the process of associating records pertinent to one customer in the database from multiple accounts and FIs is shown. The process of FIG. 4 is repeated for each customer for whom data are provided, and can be repeated to update the customer's aggregate data each time a transaction for one of that customer's accounts is received.

At block 400, upon receiving a transaction for an account of a given customer with a financial instrument of a given FI, the account linking module 152 determines which accounts at that FI are owned by the same customer.

At block 402, the transaction is associated with the transactions involving other accounts of the customer at the same FI. This can be accomplished by assigning to each transaction involving each account of the customer a common unique value of one field of the database 106. If this is the very first transaction of the customer processed by the account linking module 152, the unique value is generated and associated with the transaction and with the customer.

At block 404, the account linking module 152 determines which accounts at other participating FIs are owned by a given customer. This information can be determined by identifying which accounts at the plurality of FIs identify the same social security number, for example. Another way to identify accounts of the same customer at different FIs is if the accounts have the same customer name and the same customer address. Additionally, the user may identify accounts at a number of FIs during the process of applying for a loan or credit card at one of the plurality of FIs. Any of these methods, or a combination of these methods may be used.

At block 406, the transactions involving other accounts of the customer at other FIs are associated with the current transaction. This can be accomplished by assigning to each transaction involving each account of the customer a common unique value of one field of the database 106. Once the database has been populated, the existing records in the database for prior transactions affecting accounts of the same customer at the plurality of FIs will already have this unique value in the designated field, and it will be sufficient to assign the same value to the designated field for the newly received transaction.

At block 408, the account linking module 152 determines whether the database contains transaction data for spending by the same customer from third party information sources, or if the new transaction is received from one of the third party sources, and an account of the customer with one of the FIs has already been identified. This identification may also be based on social security number, name and address, or other information made available by the third party.

At block 410, the third party transactions are associated in the database 106 with the transactions involving accounts of the same customer. This can be accomplished by assigning the unique value to the designated field in common with the other transactions involving one of the various accounts of the same customer with one of the FIs.

At block 412, a determination is made whether the customer is single or if the customer has a spouse or domestic partner, such that the aggregate spending by both partners should be considered in the aggregate.

At block 414, a determination is made whether the customer's partner has one or more accounts at any of the participating FIs.

At block 416, the partner's transaction data is associated with the same customer in the spending database 106. This can be done by assigning the same unique value to a field in the record of both the customer and the partner.

FIG. 5 is a flow chart showing an example of the computation of a plurality of benchmarks for a given customer, which provide a first FI with insight into the total spending by a given customer of that FI, and of the share of the customer's total spending that is made using the financial instruments of that FI.

In some embodiments, the information provided to the first FI tells the first FI about aggregate spending by the customer, in terms of total spending, totals spent using particular types of financial instruments, totals spent on certain types of goods or services, total spending via a given trade channel (e.g., Internet purchases). In these embodiments, the first FI is not given the details of which other FIs have account relationships with the customer, or how the total spending is divided among other FIs. This approach identifies cross selling and promotional opportunities to the first FI, while avoiding giving the first FI specific details of the customer's account relationships with the remainder of the plurality of FIs.

At block 500, all of the spending transactions by the customer or domestic unit (customer plus spouse or domestic partner) are added up. For example, if all of these transactions have been given a unique value in one field of the database (per the above description of FIG. 4), then all of the transactions having that unique identifier are added.

At block 502, any duplicate entries or return credits are subtracted. A duplicate entry might occur, for example, if the transaction aggregator 100 receives a transaction record for a single purchase from the FI that issued the credit card used to make the purchase, and another transaction record for the same purchase from the acquirer FI that makes payment to the merchant from which the purchase is made. Likewise, since the benchmarks are based on total spending, credits applied to the customer's account for returned merchandise are also subtracted.

At block 504, the first benchmark B1 is computed as a ratio of spending of the customer or domestic unit using accounts at the first financial institution to the total spending of the customer or domestic unit using all of the accounts at all of the plurality of financial institutions. This gives the first FI a view of its “market share” of that customer's total spending using credit and debit instruments.

At block 506, all of the spending transactions by the given customer are grouped by time periods (e.g., month, calendar quarter, year or the like). In some embodiments, the length of each time period is predetermined, allowing automated reports to be generated without waiting for a request from the first FI. In other embodiments, the first FI chooses the length of each time period, for customized benchmark reporting, and transmits a request to the benchmarking module 110 in order to receive the benchmarks.

At block 508, the first benchmark B1 may be computed separately for each time period, to determine how the first FIs share of the customer's spending relative to all of the customer's spending has fared over time, and may provide information that is completely hidden when the first FI can only see the total of its own spending. This feedback can be used to determine the first FI's future programs, and to measure the success of past programs. For example, in a given period, a given customer's spending using the financial instruments of the first FI may have increased by 33%, which appears favorable. If, however, during the same period the customer has increased all spending by 50%, then the first FI is actually getting a smaller share of the customer's business, and can use this information to take affirmative acts to get back its previous share of the customer's spending. Also, by tracking the first FI's share of the customer's total spending at specific time periods, the first FI can correlate its share of the customer's total spending with a promotion or program that the first FI previously offered to that customer, to better assess the effectiveness of that past promotion or program.

At block 510, the spending by the given customer is classified by type of financial instrument. For example, for the given customer, separate subtotals are computed for the sum of all credit instrument spending using cards, and all spending using other devices types.

At block 512, a second benchmark B2 is computed as a ratio of spending by the customer or domestic unit using a given type of financial instrument issued by the first financial institution to a total spending of the customer or domestic unit using the same type of financial instrument issued by all of the plurality of financial institutions.

At block 514, the spending by the given customer is classified by type of goods or services.

At block 516, a third benchmark B3 is computed as a ratio of spending by the customer or domestic unit on a category of goods or services using accounts at the first financial institution to a total spending of the customer or domestic unit on that category of goods or services using all of the plurality of financial institutions. This ratio can be separately computed for each class of goods or services of particular interest to the first FI. Before targeting a promotion or program, this type of benchmark can identify opportunities to market promotional goods or services to the customer to whom the first FI has not previously made extensive sales of those goods or services. After the promotion or program has been implemented, this benchmark can provide an indication of the success of the program.

At block 518, the spending by the given customer is classified by merchant or marketing channel. For this purpose, the granularity may be as fine as individual merchants, or the merchants may be clustered by type (e.g., specialty store, department store, or superstore). Further, marketing channels can include such different channels as bricks and mortar stores, mail order, Internet purchases, trade show purchases or the like.

At block 520, a fourth benchmark B4 is computed as a ratio of spending by the customer or domestic unit on a merchant (or category of merchant) or trade channel using accounts at the first financial institution to a total spending of the customer or domestic unit on that merchant (or category of merchant) or trade channel using all of the plurality of financial institutions. This ratio can be separately computed for each merchant (or category of merchant) or trade channel of particular interest to the first FI.

The process of FIG. 5 is repeated for each customer of interest to the first FI. These benchmarks are examples, and are not intended to be exclusive. Although FIG. 5 shows these benchmarks performed in one sequence, the benchmarks can be performed in any sequence. Different benchmarks may be substituted, added or deleted, as desired.

Although FIG. 5 shows a single calculation block for each benchmark, and does not expressly show loops for repeated execution, the computation blocks 504, 508, 512, 516 and 520 of FIG. 5 are repeated for each customer, for each FI, and for each subclass of benchmark (e.g., each type of financial instrument, each class of goods services, each merchant, class of merchant, or marketing channel, and for each pertinent period of time.).

Further, in some embodiments, the benchmark computations of FIG. 5 are automatically performed, and the results automatically sent to the first FI, without waiting for a request from the first FI. In other embodiments, the first FI is provided with a graphical user interface (GUI) that enables the first FI to interactively select which benchmarks are provided, at which time they are provided, and in what sequence and format they are provided. Although the example of a first FI is given, the same procedure is applied for the second and subsequent participating FI. Each participating FI is provided a unique set of benchmarks identifying its share of each respective customer's total spending using financial instruments of participating FIs and third parties.

In some embodiments, upon computation of the desired benchmarks, the benchmarking module 110 automatically transmits the benchmark data to a computer executing a network based application program run by the subscriber 120, without waiting for a subscriber request. In other embodiments, the benchmarks are only transmitted to the subscriber 120 when the subscriber requests them using the user interface GUI of the subscriber interface program. In some embodiments, the subscriber GUI displays a list of the benchmarks that can be requested, and fields in which the subscriber can enter any parameters (such as dates, report granularity, etc.).

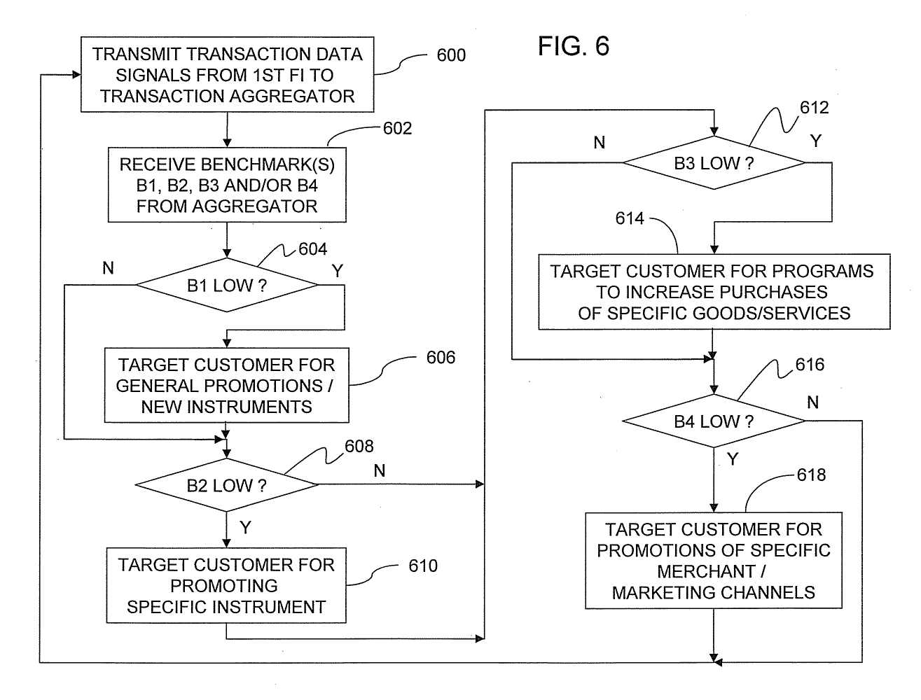

FIG. 6 is a flow chart of a method performed by the first FI. In some embodiments, any or all of the blocks may be performed automatically by a programmed computer processor 222 of the first FI.

At block 600, the first FI 222 transmits signals representing transactions made by a customer or domestic unit of the first FI during a given period to a transaction aggregator 100. The transaction aggregator 100 stores data representing the transactions in a database 106 in a machine readable storage medium 104. The transactions affect one or more accounts of the customer or domestic unit at the first FI 222. The transaction aggregator 100 also receives additional data representing additional transactions affecting one or more accounts of the same customer or domestic unit at one or more second FIs 224, 226.

At block 602, the first FI 222 receives from the transaction aggregator 100 signals representing at least one benchmark B1, B2, B3 and/or B4 (discussed above with reference to FIG. 5). The benchmark(s) is (are) in part based on the data representing the transactions of the customer or domestic unit at the first FI 222 and in part based on data corresponding to a plurality of accounts of the customer or domestic unit at a plurality of FIs 222, 224, 226 including the first FI 222.

At block 604, the first FI 222 considers whether the benchmark B!, which is a ratio of spending of the customer or domestic unit using accounts at the first FI 222 to a total spending of the customer or domestic unit using all of the accounts at all of the plurality of FIs 222, 224, 226. If this ratio is below a predetermined threshold, block 606 is performed.

At block 606, the first FI 222 selects a program to increase a fraction of the total spending by the customer or domestic unit that is made using accounts at the first FI 222. The selection is based on the benchmark received from the transaction aggregator 100. For example, if the first FI determines that its share of the customer's spending is below a desired threshold, the customer may be offered a lower interest rate, a warranty on items purchased with the instrument, extra airline miles, a new type of financial instrument, or other incentive to increase general usage. If the benchmarks indicate that the ratio B1 is low during a specific period (e.g., the Christmas shopping season), then the incentive may be offered to the customer for purchases made during a specific limited time period. The selection may be automated, and may follow an ordered decision tree process. The first FI then transmits information to the customer or domestic unit requesting participation by the customer or domestic unit in the program. The offer may be transmitted to the customer electronically (e.g., by email), or by other method.

At block 608, the first FI 222 considers the benchmark B2, which is a ratio of spending by the customer or domestic unit using a given type of financial instrument issued by the first FI 222 to a total spending of the customer or domestic unit using the same type of financial instrument issued by all of the plurality of FIs. If the benchmark B2 is too low, then block 610 is executed.

At block 610, the first FI 222 selects a program to increase a fraction of the total spending by the customer or domestic unit using the given type of financial instrument issued by the first FI 222. The selection is based on the benchmark B2. For example, the first FI may offer incentives tied to the use of the specific type of financial instrument, such as a lower interest rate, extra airline miles, or a warranty on items purchased with the specific type of instrument. The offer may be transmitted to the customer electronically (e.g., by email), or by other method.

At block 612, the first FI 222 considers the benchmark B3, which is a ratio of spending by the customer or domestic unit on a category of goods or services using accounts at the first FI 222 to a total spending of the customer or domestic unit on the category of goods or services using all of the plurality of FIs 222, 224, 226. If the ratio B3 is lower than a predetermined value, then block 614 is executed.

At block 614, the first FI 222 selects a program to increase a fraction of the total spending by the customer or domestic unit on the category of goods or services that is made using accounts at the first FI. The selection is based on the benchmark B3. For example, the first FI 222 may partner with a manufacturer or importer that directly offers that category of goods or services to the customer, with incentives provided from the first FI to the customer for such purchases. Alternatively, the first FI may enter a joint marketing program with a manufacturer or importer including advertisements that specifically promote the use of the first FI's instruments to purchase the category of goods or services. The advertisement may be transmitted to the customer electronically (e.g., by email), may be automatically displayed when the customer visits the web site of the first FI, or by other method. These are merely examples, and the use of other types of incentives or programs are also contemplated.

At block 618, the first FI 222 considers the benchmark B4, which is a ratio of purchases by the customer or domestic unit from a given merchant category or sales channel using accounts at the first FI 222 to a total spending of the customer or domestic unit from the same merchant category or sales channel using all of the accounts at all of the plurality of FIs 222, 224, 226. If the ratio B4 is too low, then block 620 is executed.

At block 620, the first FI 222 selects a program to increase a fraction of the total spending by the customer or domestic unit on purchases from the given merchant category or sales channel using accounts at the first FI 222. The selection is based on the benchmark B4. For example, the first FI 222 may enter a joint marketing program with a merchant including advertisements that specifically promote the use of the first FI's instruments to purchase the goods or services from that merchant. The advertisements may be transmitted to the customer electronically (e.g., by email), may be automatically displayed when the customer visits the web site of the first FI, or by other method. These are merely examples, and the use of other types of incentives or programs are also contemplated.

When the promotions and incentives have been executed, the first FI can repeat the entire process periodically (e.g., quarterly, semi-annually or annually), as indicated by the loop returning to block 600. When the first FI 222 transmits subsequent transaction data to the transaction aggregator 100, the transactions will reflect the effectiveness of the implemented promotions and programs at achieving the objectives of the first FI 222, providing feedback to the system. The subsequent benchmarks reflecting the implementation of these incentives and programs provide further insight to the first FI on whether to continue or broaden those programs and incentives, or apply different programs and incentives to the same customer.

Other capabilities can be provided by the use of the data aggregation. For example, at least one of the transactions may involve at least one dispute report by the customer at the first financial institution 222, and the benchmark may be a value that indicates a likelihood of dispute reports by the customer that match at least criterion for inappropriate use of dispute reports.

Although the invention has been described in terms of examples and embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method, comprising:
receiving signals representing transactions made by a customer or domestic unit during a given period from a plurality of financial institutions, the transactions affecting one or more accounts of the customer or domestic unit at each of the plurality of financial institutions;
storing data representing the transactions in a machine readable storage medium;
computing at least one benchmark that is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions; and
transmitting data representing the benchmark to the first financial institution via a network.

2. The method of claim 1, wherein:
the transactions represent spending by the customer;
the benchmark is a ratio of spending of the customer or domestic unit using accounts at the first financial institution to a total spending of the customer or domestic unit using all of the accounts at all of the plurality of financial institutions.

3. The method of claim 1, wherein:
the transactions represent spending by the customer;
the benchmark is a ratio of spending by the customer or domestic unit on a category of goods or services using accounts at the first financial institution to a total spending of the customer or domestic unit on the category of goods or services using all of the plurality of financial institutions.

4. The method of claim 1, wherein:
the transactions represent spending by the customer;
the benchmark is a ratio of spending by the customer or domestic unit using a given type of financial instrument issued by the first financial institution to a total spending of the customer or domestic unit using the same type of financial instrument issued by all of the plurality of financial institutions.

5. The method of claim 4, wherein the financial instrument is a credit card or debit card.

6. The method of claim 1, wherein:
the computing includes computing first and second values of the benchmark corresponding to respective first and second time periods; and
the transmitting includes transmitting an indication of a trend in the benchmark over time.

7. The method of claim 1, wherein:
the transactions represent spending by the customer;
the benchmark is a ratio of purchases by the customer or domestic unit from a given merchant category or sales channel using accounts at the first financial institution to a total spending of the customer or domestic unit from the same merchant category or sales channel using all of the accounts at all of the plurality of financial institutions.

8. The method of claim 1, wherein in the transmitting includes transmitting the benchmark data to a computer executing a network based application program run by the subscriber.

9. The method of claim 1, wherein at least some of the financial institutions are banks that issue credit cards, and at least some of the signals are received by way of a network that:
provides an authorization service for credit card transactions by the customer, and provides a clearing and settlement service to transfer payment information between the first financial institution and other financial institutions.

10. The method of claim 1, wherein at least some of the transactions correspond to non-credit card transfers between accounts of the customer or domestic unit.

11. A method, comprising:
transmitting signals representing transactions made by a customer or domestic unit during a given period from a first financial institution to a transaction aggregator via a network for storing of data representing the transactions in a machine readable storage medium by the transaction aggregator, wherein the transactions affect one or more accounts of the customer or domestic unit at the first financial institution, and the transaction aggregator receives additional data representing additional transactions affecting one or more accounts of the same customer or domestic unit at one or more second financial institutions;
receiving from the transaction aggregator signals representing at least one benchmark that is in part based on the data representing the transactions of the customer or domestic unit at the first financial institution and in part based on data corresponding to a plurality of accounts of the customer or domestic unit at a plurality of financial institutions, wherein the plurality of financial institutions includes the first financial institution and the one or more second financial institutions.

12. The method of claim 11, wherein the benchmark is a ratio of spending of the customer or domestic unit using accounts at the first financial institution to a total spending of the customer or domestic unit using all of the accounts at all of the plurality of financial institutions, and the method further comprises:
selecting a program of the first financial institution to increase a fraction of the total spending by the customer or domestic unit that is made using accounts at the first financial institution, the selecting being based on the benchmark received from the transaction aggregator;
transmitting information from the first financial institution to the customer or domestic unit requesting participation by the customer or domestic unit in the program.

13. The method of claim 11, the benchmark is a ratio of spending by the customer or domestic unit on a category of goods or services using accounts at the first financial institution to a total spending of the customer or domestic unit on the category of goods or services using all of the plurality of financial institutions, and the method further comprises:
selecting a program of the first financial institution to increase a fraction of the total spending by the customer or domestic unit on the category of goods or services that is made using accounts at the first financial institution, the selecting being based on the benchmark;
transmitting information from the first financial institution to the customer or domestic unit requesting participation by the customer or domestic unit in the program.

14. The method of claim 11, wherein the benchmark is a ratio of spending by the customer or domestic unit using a given type of financial instrument issued by the first financial institution to a total spending of the customer or domestic unit using the same type of financial instrument issued by all of the plurality of financial institutions, and the method further comprises:
selecting a program of the first financial institution to increase a fraction of the total spending by the customer or domestic unit using the given type of financial instrument issued by the first financial institution, the selecting being based on the benchmark;
transmitting information from the first financial institution to the customer or domestic unit requesting participation by the customer or domestic unit in the program.

15. The method of claim 11, wherein the benchmark is a ratio of purchases by the customer or domestic unit from a given merchant category or sales channel using accounts at the first financial institution to a total spending of the customer or domestic unit from the same merchant category or sales channel using all of the accounts at all of the plurality of financial institutions, and the method further comprises:
selecting a program of the first financial institution to increase a fraction of the total spending by the customer or domestic unit on purchases from the given merchant category or sales channel using accounts at the first financial institution, the selecting being based on the benchmark;
transmitting information from the first financial institution to the customer or domestic unit requesting participation by the customer or domestic unit in the program.

16. A system, comprising:
a programmed processor coupled to a network for receiving signals representing transactions made by a customer or domestic unit during a given period from a plurality of financial institutions, the transactions affecting one or more accounts of the customer or domestic unit at each of the plurality of financial institutions;
a storage device coupled to the processor, the processor causing the storage device to store data representing the transactions therein;
the processor being programmed to compute at least one benchmark that is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions; and
the processor being programmed to transmit data representing the benchmark to the first financial institution.

17. The system of claim 16, wherein:
the transactions represent spending by the customer;
the benchmark is a ratio of spending of the customer or domestic unit using accounts at the first financial institution to a total spending of the customer or domestic unit using all of the accounts at all of the plurality of financial institutions.

18. The system of claim 16, wherein at least some of the financial institutions are banks that issue credit cards, and the network:
provides an authorization service for credit card transactions by the customer, and
provides a clearing and settlement service to transfer payment information between the first financial institution and other financial institutions.

19. A system, comprising:
a computer processor programmed for transmitting signals representing transactions made by a customer or domestic unit during a given period from a first financial institution to a transaction aggregator for storing of data representing the transactions in a machine readable storage medium by the transaction aggregator, wherein the transactions affect one or more accounts of the customer or domestic unit at the first financial institution, and the transaction aggregator receives additional data representing additional transactions affecting one or more accounts of the same customer or domestic unit at one or more second financial institutions;
said computer processor receiving from the transaction aggregator signals representing at least one benchmark that is in part based on the data representing the transactions of the customer or domestic unit at the first financial institution and in part based on data corresponding to a plurality of accounts of the customer or domestic unit at a plurality of financial institutions, wherein the plurality of financial institutions includes the first financial institution and the one or more second financial institutions.

20. The system of claim 19, wherein the benchmark is a ratio of spending of the customer or domestic unit using accounts at the first financial institution to a total spending of the customer or domestic unit using all of the accounts at all of the plurality of financial institutions, and the processor is further if further programmed for:
selecting a program of the first financial institution to increase a fraction of the total spending by the customer or domestic unit that is made using accounts at the first financial institution, the selecting being based on the benchmark received from the transaction aggregator; and
transmitting information from the first financial institution to the customer or domestic unit requesting participation by the customer or domestic unit in the program.

21. A machine readable storage medium encoded with computer program code, wherein when the computer program code is executed by a processor, the processor performs a method, comprising:
receiving signals representing transactions made by a customer or domestic unit during a given period from a plurality of financial institutions, the transactions affecting one or more accounts of the customer or domestic unit at each of the plurality of financial institutions;
storing data representing the transactions in a machine readable storage medium;
computing at least one benchmark that is in part based on a portion of the data corresponding to one or more of the accounts of the customer or domestic unit at a first one of the plurality of financial institutions and in part based on the data corresponding to all of the one or more accounts of the customer or domestic unit at all of the plurality of financial institutions; and
transmitting data representing the benchmark to the first financial institution.

22. The machine readable storage medium of claim 21, wherein:
the transactions represent spending by the customer;
the benchmark is a ratio of spending of the customer or domestic unit using accounts at the first financial institution to a total spending of the customer or domestic unit using all of the accounts at all of the plurality of financial institutions.

23. The machine readable storage medium of claim 22, wherein:
the transactions represent spending by the customer;
the benchmark is a ratio of spending by the customer or domestic unit on a category of goods or services using accounts at the first financial institution to a total spending of the customer or domestic unit on the category of goods or services using all of the plurality of financial institutions.

24. The machine readable storage medium of claim 22, wherein:
the transactions represent spending by the customer;
the benchmark is a ratio of spending by the customer or domestic unit using a given type of financial instrument issued by the first financial institution to a total spending of the customer or domestic unit using the same type of financial instrument issued by all of the plurality of financial institutions.

25. A machine readable storage medium encoded with computer program code, wherein when the computer program code is executed by a processor, the processor performs a method, comprising:
transmitting signals representing transactions made by a customer or domestic unit during a given period from a first financial institution to a transaction aggregator for storing of data representing the transactions in a machine readable storage medium by the transaction aggregator, wherein the transactions affect one or more accounts of the customer or domestic unit at the first financial institution, and the transaction aggregator receives additional data representing additional transactions affecting one or more accounts of the same customer or domestic unit at one or more second financial institutions;
receiving from the transaction aggregator signals representing at least one benchmark that is in part based on the data representing the transactions of the customer or domestic unit at the first financial institution and in part based on data corresponding to a plurality of accounts of the customer or domestic unit at a plurality of financial institutions, wherein the plurality of financial institutions includes the first financial institution and the one or more second financial institutions.

26. The machine readable storage medium of claim 25, wherein the benchmark is a ratio of spending of the customer or domestic unit using accounts at the first financial institution to a total spending of the customer or domestic unit using all of the accounts at all of the plurality of financial institutions, and the method further comprises:
selecting a program of the first financial institution to increase a fraction of the total spending by the customer or domestic unit that is made using accounts at the first financial institution, the selecting being based on the benchmark received from the transaction aggregator;
transmitting information from the first financial institution to the customer or domestic unit requesting participation by the customer or domestic unit in the program.
